(19) United States
(12) Patent Application Publication
(10) Pub. No.: US 2004/0156344 A1
(43) Pub. Date: Aug. 12, 2004

(54) Blue tooth internet communicating system having vocal communicating device

(76) Inventor: Mark Yung, Hsin Chuang City (TW)

Correspondence Address: Mark Tung, P.O. Box 4-67, Hsin Chuang, Taipei, 242, TW

(21) Appl. No.: 10/361,287

(22) Filed: Feb. 7, 2003

(51) Int. Cl. H04Q 7/24

(52) U.S. Cl. 370/338; 370/352

(57) ABSTRACT

A blue tooth internet communicating system includes a blue tooth communicating device having a processor device, a network control device coupled to the processor device for communicating with various network systems, a blue tooth device coupled to the processor device to process network signals to and from the network control device, and a phone connector coupled to the processor device. The blue tooth device and the processor device may process vocal signals to and from the phone connector, and may process network signals to and from the network control device simultaneously.

### BACKGROUND OF THE INVENTION

1. Field of the Invention

The present invention relates to an internet communicating system, and more particularly to a blue tooth internet communicating system having vocal communicating device for allowing packages or information or other network signals and vocal signals to be simultaneously communicated with each other by users.

2. Description of the Prior Art

Various kinds of telecommunicating facilities or devices have been developed and widely used today, and comprise such as portable phones, mobile phones, cellular phones, wireless network access devices, wireless network communicating devices or cards, etc., for allowing people to communicate with each other easily and quickly today.

However, the typical wireless network access devices, wireless network communicating devices or cards may be used to communicate with packages, information or other network signals only, and may not be used to communicate with each other with vocal signals.

Accordingly, after transmitting packages, information or other network signals, via such as the typical wireless network access devices, wireless network communicating devices or cards, the users may have to call the other receiving users with phones, that the packages, information or other network signals have been transmitted to them.

The interfaces of the typical internet communicating systems, or of the typical wireless network access devices, the wireless network communicating devices or cards may be used to communicate with packages, information or other network signals only. The interfaces of the typical portable phones, mobile phones, cellular phones, or the other phones may be used to communicate with each other with vocal signals only, but may not be used to transmit the packages, information or other network signals.

The present invention has arisen to mitigate and/or obviate the afore-described disadvantages of the conventional telecommunicating facilities or devices.

### SUMMARY OF THE INVENTION

The primary objective of the present invention is to provide a blue tooth internet communicating system for allowing the users to communicate with each other with packages or information or other network signals and vocal signals simultaneously.

In accordance with one aspect of the invention, there is provided a blue tooth internet communicating system comprising a blue tooth communicating device including a processor device, a network control device coupled to the processor device of the blue tooth communicating device, for communicating with network systems, a blue tooth device coupled to the processor device of the blue tooth communicating device, to process network signals to and from the network control device, and a phone connector coupled to the processor device of the blue tooth communicating device. The blue tooth device and the processor device of the blue tooth communicating device are provided for processing vocal signals to and from the phone connector, and for processing the network signals to and from the network control device. Accordingly, the end users may transmit or communicate with each other with the packages or information or other network signals with the network control device, the processor device, and the blue tooth module or device of the blue tooth communicating device, and may simultaneously transmit or communicate with each other with the vocal signals with telecommunicating cables or wires and blue tooth ear pieces, via the phone connector and the processor device and the blue tooth module or device.

The blue tooth communicating device may further include a reset switch coupled to the processor device, for resetting purposes.

The blue tooth communicating device may further include a vocal analog/digital converter coupled between the blue tooth module or device and the phone connector, to convert vocal signals and digital signals between the blue tooth module or device and the phone connector.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a blue tooth internet communicating system in accordance with the present invention;

FIG. 2 is a block diagram of a blue tooth communicating device for the blue tooth internet communicating system;

FIG. 3 is a block diagram illustrating the communication of the packages or information or other network signals with the blue tooth internet communicating system; and

FIG. 4 is a block diagram illustrating the communication of the vocal signals with the blue tooth internet communicating system.

### DETAILED DESCRIPTION OF THE PREFERRED EMBODIMENT

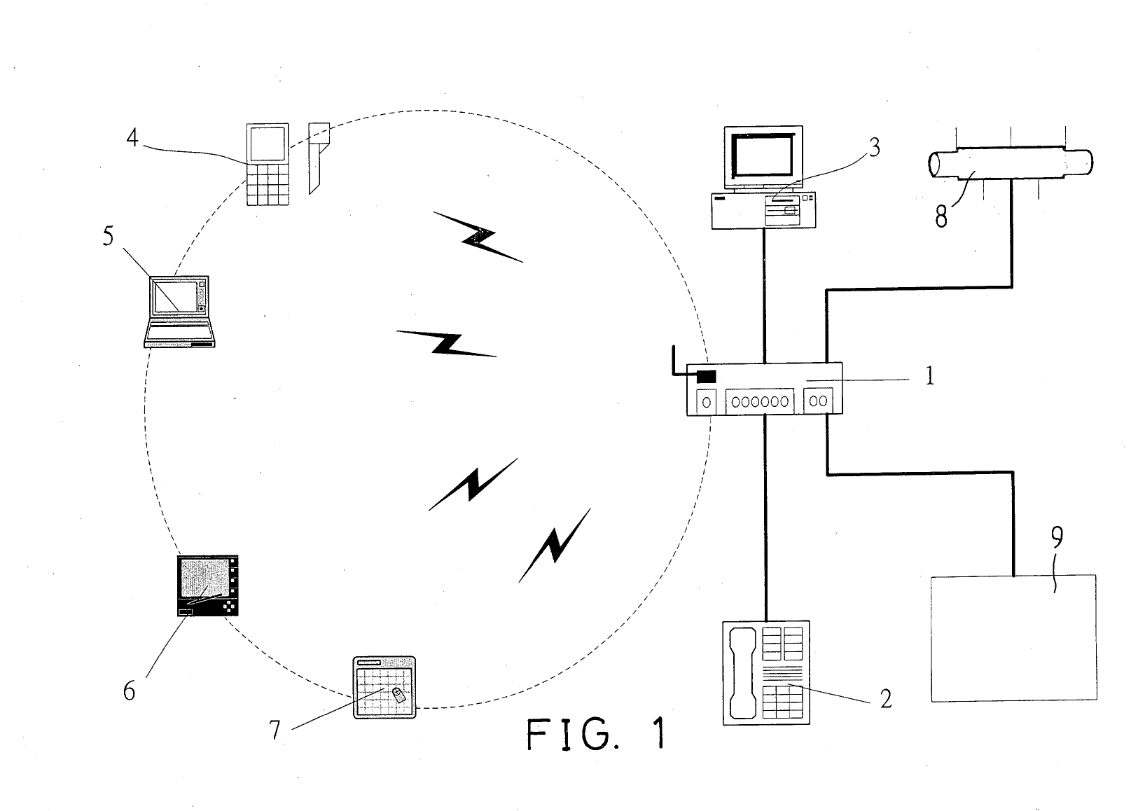

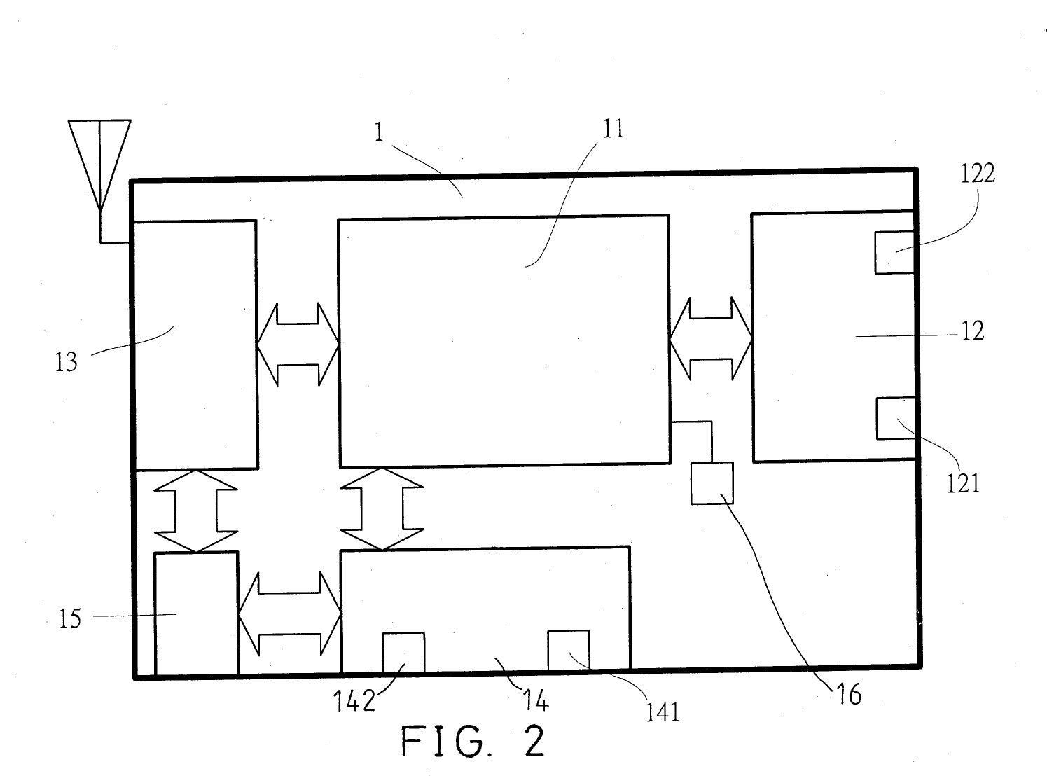

Referring to the drawings, and initially to FIG. 1, a blue tooth internet communicating system in accordance with the present invention comprises a blue tooth communicating device 1 (FIGS. 1, 2) for coupling to a phone operator 2, an end user 3, such as a computer facility 3, and/or for coupling to ethernet systems 8, or telecommunicating cables or wires 9, for allowing the blue tooth communicating device 1 to wirelessly communicate with the other users, such as the notebook computers 5, the personal digital assistants (PDA) 6, the planar computers 7, and the blue tooth ear pieces 4.

Referring next to FIG. 2, the blue tooth communicating device 1 includes a processor device 11 for signal processing purposes, a network control chip or device 12 coupled to the processor device 11, a blue tooth module or device 13 coupled to the processor device 11, a phone connector 14 coupled to the processor device 11, and a vocal analog/digital converter 15 coupled between the blue tooth module or device 13 and the phone connector 14.

A reset key or switch 16 may be coupled to the processor device 11, for resetting purposes. The network control device 12 includes a port or coupler 121 for coupling to ethernet systems 8, and another port or coupler 122 for coupling to the end user 3, such as the computer facility 3 (FIG. 1), the notebook computers, the personal digital assistants (PDA), the planar computers, or the like, and for allowing the end user 3 to communicate with the other end users, such as the notebook computers 5, the personal digital assistants (PDA) 6, the planar computers 7, and the like, with the packages or information or other network signals.

The packages or information or other network signals transmitted into the network control device 12, from such as the other end users 5-7, may then be transmitted to and processed by the processor device 11 and the blue tooth module or device 13, and then sent to the end user 3. On the contrary, the packages or information or other network signals from the end user 3 may also be processed by the processor device 11 and the blue tooth module or device 13, and then transmitted to the network control device 12, in order to communicate with the other end users 5-7 via the ethernet systems 8 and the network control device 12, the processor device 11 and the blue tooth module or device 13.

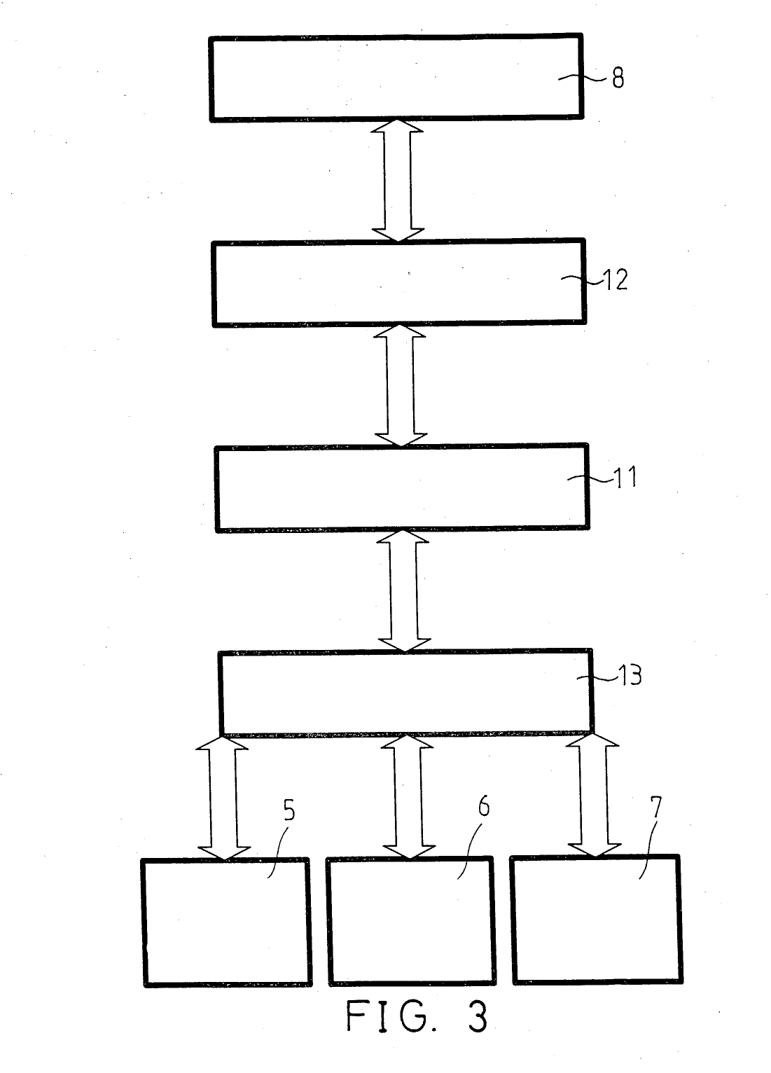

Accordingly, as shown in FIGS. 1-3, the packages or information or other network signals may be transmitted and communicated between the end users 3, and 5-7, with the network control device 12, the processor device 11 and the blue tooth module or device 13 of the blue tooth communicating device 1.

The phone connector 14 of the blue tooth communicating device 1 is coupled to the processor device 11, and includes a port or coupler 141 for coupling to the telecommunicating cables or wires 9, and another port or coupler 142 for coupling to the phone operator 2. The vocal analog/digital converter 15 is coupled between the phone connector 14 and the blue tooth module or device 13, to convert the vocal signals from the phone connector 14 into digital signals that will then be sent to the blue tooth module or device 13, or to convert the digital signals from the blue tooth module or device 13 into vocal signals that will then be sent to the phone connector 14.

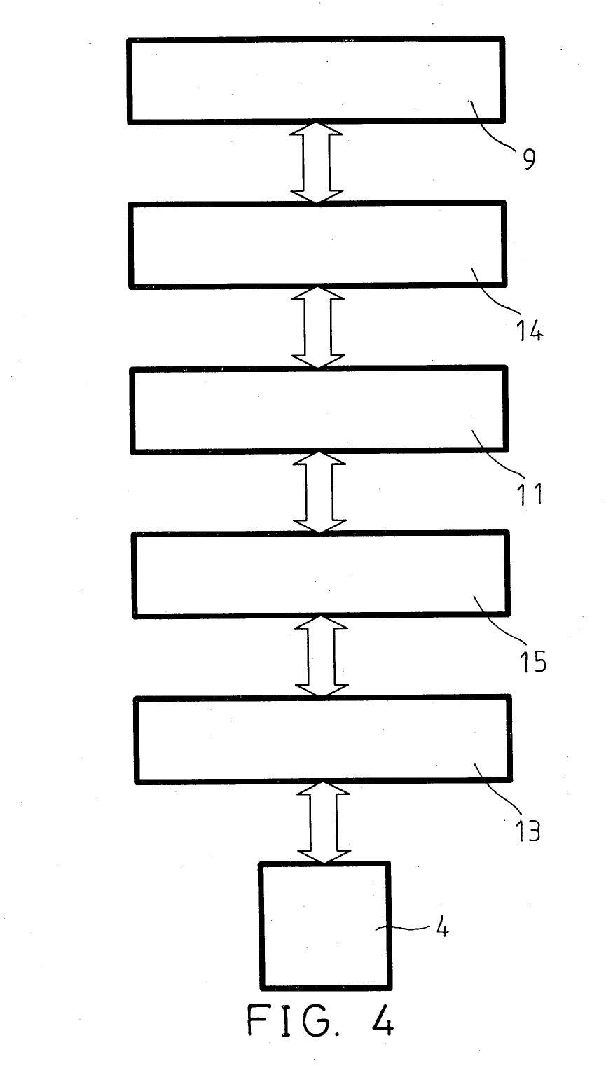

In operation, as shown in FIGS. 2 and 4, the vocal signals may be communicated between the end users 3 and 5-7 (FIG. 1) with the telecommunicating cables or wires 9 and the blue tooth ear pieces 4, via the phone connector 14 and the processor device 11 and the vocal analog/digital converter 15 and the blue tooth module or device 13.

In operation, the packages or information or other network signals may be transmitted and communicated between the end users 3, 5-7, with the blue tooth communicating device 1 and the ethernet systems 8, and simultaneously, the vocal signals may be transmitted and communicated between the end users 3, 5-7, with the blue tooth communicating device 1 and the telecommunicating cables or wires 9.

Accordingly, the blue tooth internet communicating system in accordance with the present invention may be provided for allowing the users to communicate with each other with packages or information or other network signals and the vocal signals simultaneously.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A blue tooth internet communicating system comprising:
a blue tooth communicating device including:
a) a processor device,
b) a network control device coupled to said processor device of said blue tooth communicating device, for communicating with network systems,
c) a blue tooth device coupled to said processor device of said blue tooth communicating device, to process network signals to and from said network control device, and
d) a phone connector coupled to said processor device of said blue tooth communicating device,
said blue tooth device and said processor device of said blue tooth communicating device being provided for processing vocal signals to and from said phone connector, and for processing the network signals to and from said network control device.

2. The blue tooth internet communicating system as claimed in claim 1, wherein said blue tooth communicating device includes a reset switch coupled to said processor device, for resetting purposes.

3. The blue tooth internet communicating system as claimed in claim 1, wherein said blue tooth communicating device further includes a vocal analog/digital converter coupled between said blue tooth module or device and said phone connector, to convert vocal signals and digital signals between said blue tooth module or device and said phone connector.
